(19) United States
(12) Patent Application Publication
(10) Pub. No.: US 2010/0094856 A1
(43) Pub. Date: Apr. 15, 2010

(54) SYSTEM AND METHOD FOR USING A LIST CAPABLE SEARCH BOX TO BATCH PROCESS SEARCH TERMS AND RESULTS FROM WEBSITES PROVIDING SINGLE LINE SEARCH BOXES

(76) Inventors: Eric Rodrick, Newbury Park, CA (US); Benjamin Woodard, Newbury Park, CA (US)

Correspondence Address: WEISS & MOY PC, 4204 NORTH BROWN AVENUE, SCOTTSDALE, AZ, 85251, US

(21) Appl. No.: 12/577,621

(22) Filed: Oct. 12, 2009

Related U.S. Application Data
(60) Provisional application No. 61/195,999, filed on Oct. 14, 2008.

(51) Int. Cl. G06F 17/30

(52) U.S. Cl. 707/706; 707/E17.014; 707/E17.008

(57) ABSTRACT

System and method for querying multiple websites using keywords entered into a search box on a browser. The search box can receive a list of keywords that are placed into multiple websites. After a process receives its start command, each process can work on retrieving information from a number of websites, for example, Google and EBay. The processes can be managed so that the system is not bogged down and the central processing unit is available for other tasks. The process can store a set of query results from the website in a database. The system can create a final grid using the query results in the database and display the final grid to the user. In addition to or separate thereto, the system can generate folders containing the query results. Links can be saved within the query results. The system does not use robots, crawlers, harvesters, agents, or scrapers. Instead, the system takes advantage of the raw HTML source freely offered by searched websites.

### REFERENCE TO RELATED APPLICATIONS

This application claims priority to U.S. Provisional Application Ser. No. 61/195,999 titled SYSTEM AND METHOD FOR BATCH PROCESSING QUERIES USING A SINGLE LINE SEARCH BOX OF WEBSITES which was filed on Oct. 14, 2008 by Benjamin Woodard and Eric Rodrick, and is hereby incorporated in its entirety, including any appendices, screen shots, and references therein.

### TECHNICAL FIELD

This application generally relates to searching, and more particularly, to a system and method for receiving keywords through a search box and generating batch processes by entering those keywords into a plurality of websites so that a user can find products, services, information, etc. in a more efficient manner.

### BACKGROUND

With the increased growth of the Internet and the World Wide Web, it is common for online users to utilize search engines to search for desired information. Many websites permit users to perform searches to identify a small number of relevant items among a much larger domain of items. As an example, several web index sites permit users to search for particular web sites among known web sites. Similarly, many online merchants provide their users with the ability to search for particular products among all of their products.

In order to perform a search, a user submits a search query containing one or more keywords within a search box. A query server program of the search engine processes the search query to identify any items that match the keywords of the search query. The set of items identified by the query server program is referred to as a “query result.” In the online merchant example, which was provided above, the query result is a set of products or services that satisfy the query. In some implementations, the query results may include items that contain only a subset of the terms of the search query. In web-based implementations, the query result is typically presented to the user as a hyper textual listing of the located items.

If the scope of the search is large, the query results may contain hundreds, thousands, or even millions of items. If a user is performing the search in order to find a single item or a small set of items, conventional approaches to ordering the items within the query result often fail to place the sought item or items near the top of the query results. This deficiency often requires the user to read through many items in the query result before reaching the sought item.

Query results are displayed based on numerical weights provided by the query server program. Search algorithms, studied extensively by computer scientists, often assign ranks to the query results based on their numerical weights and display the results based on rank thereby reducing the amount of time spent for searching. Each search website, including Amazon, Google, Bing, and Yahoo, has its own unique algorithm providing various results that are typically not the same.

### SUMMARY

This summary is provided to introduce a selection of concepts in a simplified form that are further described below in the DESCRIPTION OF THE APPLICATION. This summary is not intended to identify key features of the claimed subject matter, nor is it intended to be used as an aid in determining the scope of the claimed subject matter.

In accordance with one aspect of the present application, a user computer system having a display screen, a graphical user interface (GUI) provided for on the display screen, and a search box displayed on the GUI for batch processing queries over a network is provided. The system includes a database for storing webpages and at least one processor. The system also includes a memory operatively coupled to the processor, the memory storing program instructions that when executed by the processor, causes the processor to perform processes. The processes include receiving at least one keyword from the user within the search box displayed on the GUI. The processes also include generating a plurality of processes, each process corresponding to the at least one keyword and at least one predetermined website. In addition, the processes include executing search queries in batches for the plurality of processes over the network. The processes include receiving set of query results from the executed search queries for the plurality of processes from the network in the form of webpages that include hypertext markup language (HTML) code, the HTML code including links pointing to listings associated with keyword matches. The processes include storing the webpages that include the HTML code along with the links pointing to listings associated with the keyword matches into the database, wherein a subset of the HTML code and the links pointing to listings associated with keyword matches is stored when the amount of the HTML code and the links is greater than a predetermined size. The processes further include displaying results on the GUI provided on the display screen using the webpages that include the HTML code along with the links pointing to listings associated with keyword matches from the database, wherein displaying the results using the HTML code and listings occurs after all processes within the plurality of processes have been completed and query results have been obtained or timed out, the results incorporating a link to the webpages from the search queries and the links within the HTML code that points to listings associated with the keyword matches, the links allowing the user to connected to the listings provided for in the query results from the executed search queries so that the user can view, interact with, or utilize the webpage's content.

In accordance with another aspect of the present application, a system is provided. The system includes at least one processor and a memory operatively coupled to the processor, the memory storing program instructions that when executed by the processor, causes the processor to perform processes. The processes include receiving at least one keyword and generating a plurality of processes, each process associated with the at least one keyword entered into at least one search engine. The processes also include executing search queries for the plurality of processes. In addition, the processes include receiving a set of query results from the executed search queries for the plurality of processes, the query results from the at least one search engine. Furthermore, the processes also include displaying the query results.

In accordance with yet another aspect of the present application, a computer-readable medium storing instructions for causing at least one processor to perform a method for processing queries is provided. The method includes receiving a plurality of keywords and generating search queries to a set of search engines using each keyword in the plurality of keywords, each search query producing query results. The method also includes displaying the query results.

In accordance with another aspect of the present application, a computer-implemented method for batch processing search queries to selected websites is presented. The method includes receiving a plurality of keywords. In addition, the method includes sending search queries using the plurality of keywords to selected websites, each search query producing query results in the form of HTML code. The method also includes displaying the query results in the form of HTML code from the search queries.

In accordance with still yet another aspect of the present application, a system is provided. The system includes a database for storing query results and at least one processor. In addition, the system includes a memory operatively coupled to the processor, the memory storing program instructions that when executed by the processor, causes the processor to perform processes. The processes include receiving at least one keyword describing a desired product from a user agent. The processes also include generating a plurality of processes, each process corresponding to the at least one keyword describing the product entered into a set of predetermined websites. The processes include executing search queries for the plurality of processes. The processes include receiving a set of query results from the executed search queries for the plurality of processes in the form of webpages having HTML code and links associated with products described by the at least one keyword. The processes include storing the query results into the database. The processes include creating a final grid using the query results from the database including the links associated with the products described by the at least one keyword from the webpages having HTML code. The processes include transmitting the final grid to the user agent.

### BRIEF DESCRIPTION OF DRAWINGS

The novel features believed to be characteristic of the application are set forth in the appended claims. In the descriptions that follow, like parts are marked throughout the specification and drawings with the same numerals, respectively. The drawing figures are not necessarily drawn to scale and certain figures may be shown in exaggerated or generalized form in the interest of clarity and conciseness. The application itself, however, as well as a preferred mode of use, further objectives and advantages thereof, will be best understood by reference to the following detailed description of illustrative embodiments when read in conjunction with the accompanying drawings, wherein:

FIG. 1 is an exemplary block diagram that shows an illustrative computer architecture used for running a batch searching program in accordance with one aspect of the present application;

FIG. 2 is a block diagram depicting an exemplary environment for executing the batch searching program in accordance with one aspect of the present application;

FIG. 3 shows an exemplary browser supporting the search box in accordance with one aspect of the present application;

FIG. 4 depicts illustrative routines for sending search queries to a number of host servers in accordance with one aspect of the present application;

FIG. 5 shows an exemplary grid showing the query results in an easy-to-read form in accordance with one aspect of the present application;

FIG. 6 provides an embodiment where illustrative query results are provided within folders in accordance with one aspect of the present application;

FIG. 7 depicts another embodiment whereby the search box for receiving keywords is provided in accordance with one aspect of the present application;

FIG. 8 shows exemplary results provided by the embodiment in accordance with one aspect of the present application;

FIG. 9A is an exemplary flow chart showing illustrative routines used by a system to generate batch processes and to display the results from those batch processes in accordance with one aspect of the present application; and

FIG. 9B is an exemplary flow chart showing illustrative processes for generating batch processes using keywords and a list of host servers in accordance with one aspect of the present application.

### DESCRIPTION OF THE APPLICATION

The description set forth below in connection with the appended drawings is intended as a description of presently preferred embodiments of the application and is not intended to represent the only forms in which the present application may be constructed and/or utilized. The description sets forth the functions and the sequence of steps for constructing and operating the application in connection with the illustrated embodiments. It is to be understood, however, that the same or equivalent functions and sequences may be accomplished by different embodiments that are also intended to be encompassed within the spirit and scope of this application.

### System Overview

Generally described, the present application relates to a system and method for finding goods, products, services, news events, blogs, etc. More specifically, the present application relates to receiving search queries from a search box whereby several processes are then executed, either concurrently or in batches, with each process having a keyword entered from the search box and distributed to a selected website. Typically, the search box can receive a list. The selected websites often can include a single line search box. The system does not use robots, crawlers, harvesters, agents, or scrapers. Instead, the system can take advantage of the raw hypertext markup language (HTML) source code freely offered by selected websites generated by host servers or webpage publishers. Through this system and method, items can be located from a plurality of available websites taking advantage of each websites unique search algorithm and/or other features. Because websites issue HTML to a browser to display search information, the websites typically cannot predict whether it is a robot, crawler, harvester, agent, or scraper. Taking advantage of this, the system and method can prepare an easy-to-follow grid using the HTML or display the results within multiple folders.

In an illustrative embodiment, the processing system can reduce the need to visit multiple websites by using a search box on a browser, the search box capable of receiving a list of keywords. Keywords can be cut and pasted in, typed in, or fed in through some other automated process. Initially, the user can enter in at least one keyword in the search box. In turn, the system can generate a plurality of processes. Each process can correspond to a keyword entered into the search box and at least one predetermined website. Often, the predetermined website includes a single line search box. Search queries can then be executed at each predetermined website using the at least one keyword. Once a search query is completed from a website, search query results can be received. A set of the results can be taken and stored into temporary files. Periodically, the system determines whether each process has been completed. When all processes have been completed or timed out, a final grid can be created using the query results from the temporary files and displayed to the user.

The processing system can provide benefits to respective websites or search engines by delivering increased visitor traffic, page views, ad revenues and clicks, visitor durations, and product and service sales to the websites or search engines. Typically, this results in higher search engine rankings and customer loyalty for and to these websites as the intrinsic natures of the system process allows viewing, utilizing, bookmarking, interfacing, and all other forms of actual webpages content access through direct and traditional web browser linkage to the real-time individual web pages of the data originating websites.

By batch processing the plurality of processes, the system and method can allow sharing of computer resources among many programs including other applications running along with the search box. Furthermore, it manages job processing and avoids dwindling computing resources with no human interaction and supervision. By keeping a high overall rate of utilization, it can better amortize the cost of a computer, especially an expensive one.

In essence, the list capable search box provided above can provide keywords into one or more targeted websites, the websites often having a single line search bar, to extract search results in a lean and highly efficient manner for massive productivity gains creating a fast and efficient search engine on today's internet. Generally, the system and method described herein utilizes sites, results, and code that is freely available to the typical user of a common browser like Mozilla or IE. Therefore, no copyright, law, protocols, or other agreements are violated. The user agent/browser technology can select how to feed keywords and how to extract keyword results differently than Mozilla or IE. The prime difference being a complete emphasis on speed by gathering and displaying targeted text information only. A user can link directly to the source site or page if they wish to see the entire page or transact with the site or page in any manner. Typically, the system and method described herein provides no redirection, no ad displays, and no framing. If the user has any interest in the displayed results, they can be exposed to the ads and banners that the source site may have by linking to the page for more details.

As will be shown below, the search box can come in a variety of forms. Keywords can be cut and pasted in, typed in, or fed in through an automated process. In alternative embodiments, the processing system can receive keywords through an upload feature whereby words are retrieved in a document, such as an Excel sheet. One skilled in the relevant art will appreciate that there are numerous ways in which keywords can be obtained. Furthermore, the term batch processing should not be construed as limiting, but one embodiment of the present application. Many additional features and elements of the present application will become apparent to one of ordinary skill in the art in the following description.

### Hardware Environment

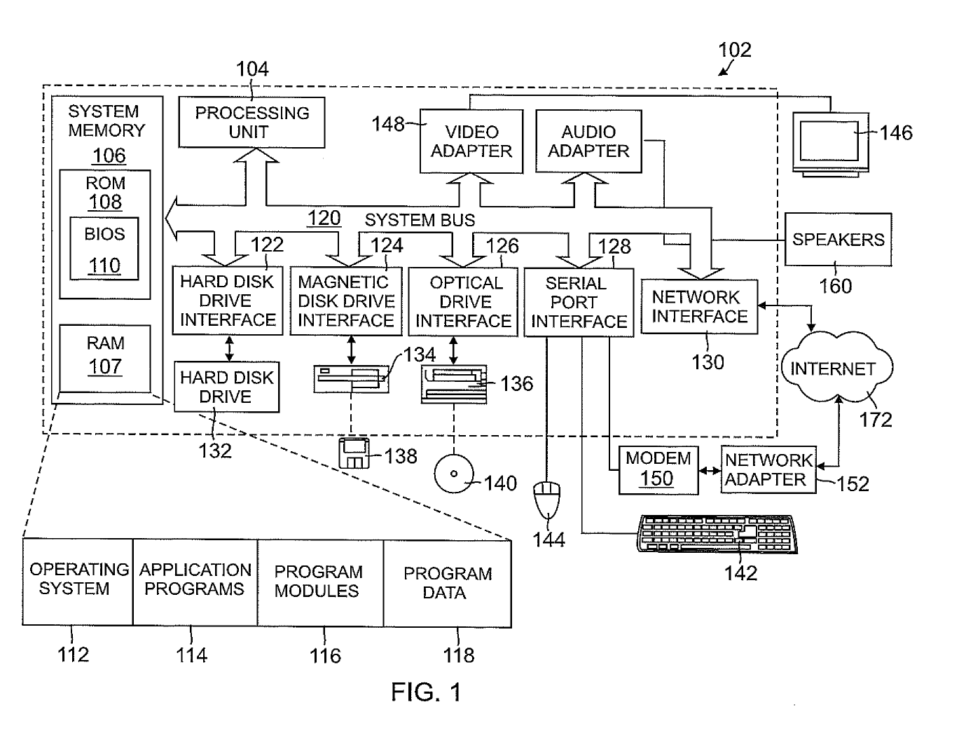

An exemplary hardware and operating environment for implementing the processing system and method of the present application can include a general purpose client computer 102 as shown in FIG. 1. Typically, the processing can be performed on a client computer 102 as shown or, in the alternative, on a host server, which will be shown later. Nonetheless, the components as described below within the client computer 102 can generally be found in each. The hardware can be represented in the form of a computer 102, which includes a processing unit 104, a system memory 106, and a system bus 120 that operatively couples various system components, including the system memory 106 to the processing unit 104. There can be only one or there can be more than one processing unit 104, such that the processor of computer 102 comprises a single central processing unit (CPU), or a plurality of processing units, commonly referred to as a parallel processing environment. The computer 102 can be a conventional computer, a distributed computer, a web server, a file server, or any other type of computer.

The system bus 120 can be any of several types of bus structures including a memory bus or memory controller, a peripheral bus, a switched fabric, point-to-point connections, and a local bus using any of a variety of bus architectures. The system memory 106 can also be referred to as simply the memory, and includes read only memory (ROM) 108 and random access memory (RAM) 107. A basic input/output system (BOIS) 110, containing the basic routines that help to transfer information between elements within the computer 102, such as during start-up, is stored in ROM 108. The computer 108 further includes a hard disk drive 132 for reading from and writing to a hard disk, not shown, a magnetic disk drive 134 for reading from or writing to a removable magnetic disk 138, and an optical disk drive 136 for reading from or writing to a removable optical disk 140 such as a CD ROM or other optical media.

The hard disk drive 132, magnetic disk drive 134, and optical disk drive 136 can be connected to the system bus 120 by a hard disk drive interface 122, a magnetic disk drive interface 124, and an optical disk drive interface 126, respectively. The drives and their associated computer-readable medium provide nonvolatile storage of computer-readable instructions; data structures, e.g., a catalog and a contextual-based index; program modules, e.g., a web service and an indexing robot; and other data for the computer 102. It should be appreciated by those skilled in the art that any type of computer-readable medium that can store data that is accessible by a computer, for example, magnetic cassettes, flash memory cards, digital video disks, RAM, and ROM, may be used in the exemplary operating environment.

A number of program modules can be stored on the hard disk 132, magnetic disk, optical disk 136, ROM 108, or RAM 107, including an operating system 112, one or more application programs 114, other program modules 116, and program data 118. A user can enter commands and information into the personal computer 102 through input devices such as a keyboard 142 and pointing device 144, for example, a mouse. Other input devices (not shown) can include, for example, a microphone, a joystick, a game pad, a tablet, a touch screen device, a satellite dish, a scanner, a facsimile machine, and a video camera. These and other input devices are often connected to the processing unit 104 through a serial port interface 128 that is coupled to the system bus 120, but can be connected by other interfaces, such as a parallel port, game port or a universal serial bus (USB).

A monitor 146 or other type of display device can also be connected to the system bus 120 via an interface, such as a video adapter 148. In addition to the monitor 146, computers typically include other peripheral output devices, such as a printer and speakers 160. These and other output devices are often connected to the processing unit 104 through the serial port interface 128 that is coupled to the system bus 120, but can be connected by other interfaces, such as a parallel port, game port, or a universal serial bus (USB).

The computer 102 can operate in a networked environment using logical connections to one or more remote computers. These logical connections can be achieved by a communication device coupled to or integral with the computer 102; the application is not limited to a particular type of communications device. The remote computer can be another computer, a server, a router, a network personal computer, a client, a peer device, or other common network node, and typically includes many or all of the elements described above relative to the computer 102, although only a memory storage device has been illustrated in FIG. 1. Computer 102 can be logically connected to the internet 172. The logical connections can include a local area network (LAN), wide area network (WAN), personal area network (PAN), campus area network (CAN), metropolitan area network (MAN), or global area network (GAN). Such networking environments are commonplace in office networks, enterprise-wide computer networks, intranets and the Internet, which are all types of networks.

When used in a LAN environment, the computer 102 can be connected to the local network through a network interface or adapter 130, which is one type of communication device. When used in a WAN environment, the computer 102 typically includes a modem 150, a network adapter 152, or any other type of communications device for establishing communications over the wide area network. The modem 150, which can be internal or external, is connected to the system bus 120 via the serial port interface 128. In a networked environment, program modules depicted relative to the personal computer 102, or portions thereof, can be stored in a remote memory storage device. It is appreciated that the network connections shown are exemplary and other means of and communications devices for establishing a communications link between the computers can be used.

The technology described herein can be implemented as logical operations and/or modules in one or more systems. The logical operations can be implemented as a sequence of processor-implemented steps executing in one or more computer systems and as interconnected machine or circuit modules within one or more computer systems. Likewise, the descriptions of various component modules can be provided in terms of operations executed or effected by the modules. The resulting implementation is a matter of choice, dependent on the performance requirements of the underlying system implementing the described technology. Accordingly, the logical operations making up the embodiment of the technology described herein are referred to variously as operations, steps, objects, or modules. Furthermore, it should be understood that logical operations can be performed in any order, unless explicitly claimed otherwise or a specific order is inherently necessitated by the claim language.

Client computer 102, as described above, was exemplary and should not be construed as limiting. Client computer 102 typically encompasses many types of other devices. Such devices may include a cell phone, personal digital assistant (PDA), stationary personal computer, IPTV remote control, web tablet, laptop computer, pocket PC, a television set capable of receiving IP based video services and mobile IP device, etc.

### Networked Environment

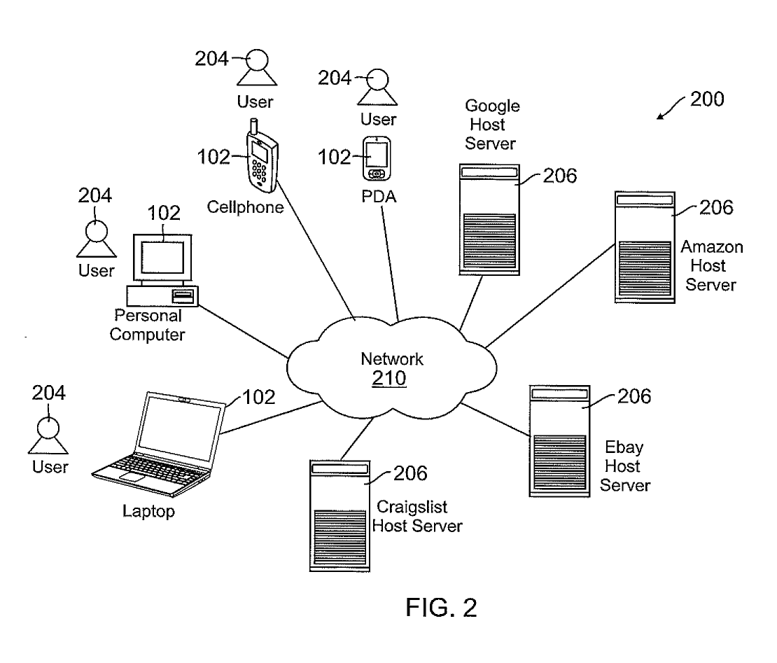

In one illustrative embodiment, client computer 102 can be incorporated into system 200 as shown in FIG. 2. Other exemplary components can include Google host server 206, Amazon host server 206, EBay host server 206, and Craigslist host server 206 coupled by network 210. One skilled in the relevant art will appreciate that there can be other host servers 206 coupled to client computer 102. Each host server 206 typically maintains a server computer that has access to other computers on the network 210. The host server 206, in addition to providing search query results, can provide services such as news, mail, or data, to computers that connect to it.

Each host server 206 can be a website, which is a group of related HTML documents and associated files, scripts, and databases that are served up by a hypertext transfer protocol (HTTP) server on the World Wide Web. The HTML documents in a website generally cover one or more related topics and are interconnected through hyperlinks. Most websites have a homepage as their starting point, which frequently functions as a table of content for the websites.

Host servers 206 generally take the form of a search engine, which often have a single line search box. Search engines are programs that typically search for keywords in files and documents found in the World Wide Web, newsgroups, Gopher menus, and FTP archives. Some search engines are used for a single Internet site, such as a dedicated search engine for a website. Other search engines search across many websites, using such agents as spiders to gather lists of available files and documents and store these lists in databases that users can search by keyword.

Typically, search engines provide webpages based on keyword matches. Webpages generally consist of HTML code with associated files for graphics and scripts. Some webpages incorporate links to other pages. In particular, links created on webpages produced by search engines link to webpages where keywords were matched.

Some host servers 206 can require a verification code to be typed in by the user 204 before the user 204 can search the host server 206. Often, the verification code is hidden in a .jpg or .bmp file so that a computer cannot automatically scan for the verification code. The user 204 can be prompted to enter a word that the host server 206 requires in order for the client computer 102 to continue to search. For example, Google sometimes requires a pass-keyword to continue providing service. In such cases, the system and method of the present application can be customized to allow the user 204 to enter in the pass-keyword in order for the search site to provide service.

User 204, within system 200, can select the host servers 206 based on their personal preferences. The more typical case, however, allows the software downloaded on the client computer 102 to set the host servers 206 that the client computer 102 can query. When the software determines the host servers 206, revenue may be generated to the batch processing system. In other embodiments, a user 204 can enter the name of the host servers 206 that they intend to use through the search box, upload feature, etc., which will be described in more details below.

As provided in FIG. 2, the Google host server 206 is an exemplary search engine which client computer 102 can query. Other queries can be performed using online auction and shopping websites, such as EBay and Amazon, and advertising websites, such as Craigslist and Kijiji. In essence, any host server 206 that allows a user 204 operating a client computer 102 to search for goods, product, and/or service can typically be used.

In alternative embodiments, the user 204 operating the client computer 102 can search for other information not related to goods, product, and/or services. Instead, the user 204 can use the system 304 to efficiently search through a number of host servers 206 to retrieve any content that host servers 206 can provide. For example, the user 204 can look for user groups, blogs, or social media related to keywords entered into the client computer 102. In addition, the keywords can be related to news events. One skilled in the relevant art will appreciate that the present application can relate to any information that the user 204 enters in keywords for and should not be limited to a system 304 for searching only products and/or services.

As described earlier, the batch processing system and method includes a client computer 102 that performs the process of querying several host servers 206. In one embodiment, the client computer 102 could download special software to perform the searches. A special toolbar on a typical browser could be provided once the software was downloaded. Alternatively, the client computer 102 could display a separate webpage where keywords could be entered into. In other embodiments, a host server 106 can perform the batch processing system and method. One skilled in the relevant art will appreciate that a host server 206 can receive keywords and provide the same results as the client computer 102 would.

Network 210 can be a group of two or more computer systems linked together. Network 210 typically transfers data from one source to another. To communicate efficiently, client computer 102 and host servers 206 connected via network 210 can use a common set of rules and signals, also known as a protocol. Generally, the protocol determines the type of error checking to be used; what data compression method, if any, will be used; how the sending device will indicate that it has finished sending a message; and how the receiving device will indicate that it has received a message. Programmers can choose from a variety of standard protocols. Existing electronic commerce systems typically use Internet Protocol (IP) usually combined with a higher-level protocol called Transmission Control Protocol (TCP), which establishes a virtual connection between a destination and a source. IP is analogous to a postal system in that it allows the addressing of a package and dropping it in the system without a direct link between the sender and the recipient. TCP/IP, on the other hand, establishes a connection between two hosts so that they can send messages back and forth for a period of time.

Simple Object Access Protocol (SOAP) is an XML-based protocol for exchanging structured and type information on the web between client computer 102 and host servers 206. Particularly useful for this system 200 is that SOAP has no application on transport semantics, which makes it highly modular and extensible.

SOAP forms the foundational layer of the web services protocol stack providing a basic messaging framework upon which abstract layers can be built. SOAP procedures can be used to correctly format a call for data. The website receiving the call for data would then return a formatted XML document with all the required results and associated data.

While SOAP is used in one embodiment, numerous other types of protocols exist. Asynchronous JavaScript and XML (AJAX) is a group of interrelated web development techniques used for creating interactive web applications or rich internet applications. With AJAX, web applications can retrieve data from the server asynchronously in the background without interfering with the display and behavior of the existing page. Data is retrieved using the XHMLHttpRequest object or through the use of remote scripting in browsers that do not support it.

Computer networks 210 can be classified as falling into one of two broad architectures; peer-to-peer or client/server architecture. Most networks 210 used for internet sales are classified as being a client/server architecture.

Host servers 206, coupled to network 210, primarily provide services to client computer 102 that connects from remote locations. Typically, host servers 206 run on multi-user operating systems such as UNIX, MVX or VMS, or at least an operating system with network services such as Windows NT, NetWard NDS, or NetWire Bindery.

For purposes of illustration, system 200, shown in FIG. 2, includes a plurality of client computers 102 and multiple host servers 206 coupled by network 210. Alternatively system 200 may include a single host server 206 along with a single client computer 102. As illustrated, system 200 may incorporate additional or fewer components and FIG. 2 should not be construed as limiting to the present scope of this application.

### Search Box

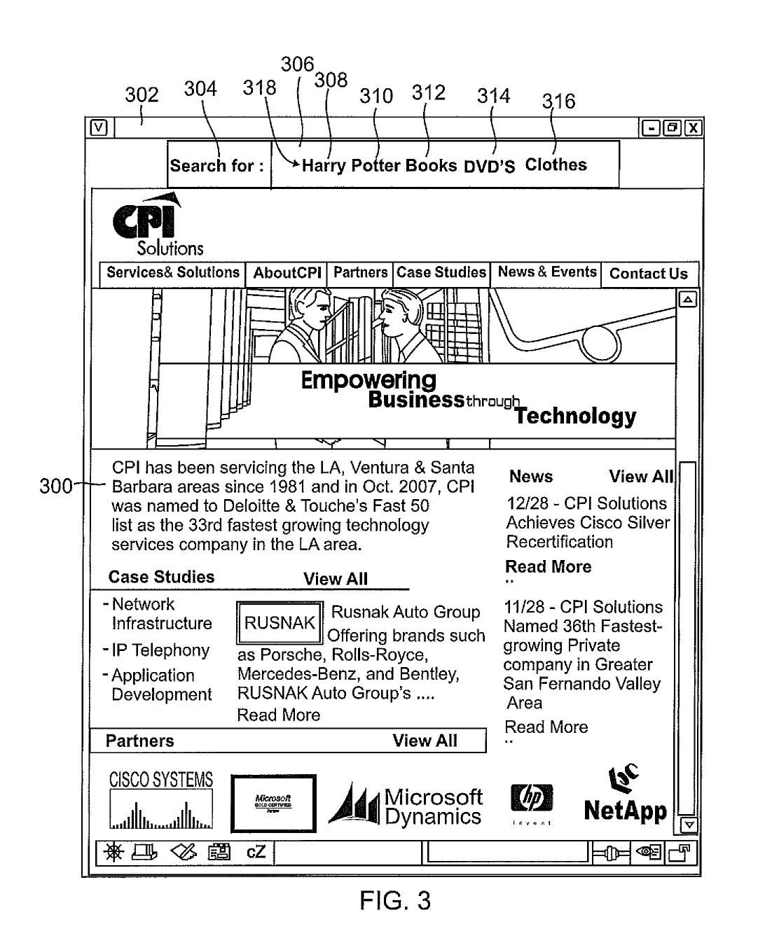

In one embodiment, operating on client computer 102 is browser 302, which executes HTML code defined in webpage 300 as depicted in FIG. 3. Browser 302 can be a software application that runs on client computers 102 that enables a user 204 to display and interact with text, images, videos, music, games, and other information typically located on a webpage 300 at a website on the World Wide Web or a local area network.

Shown within browser 302, in one illustrative embodiment, the batch processing system 304 can be provided. The batch processing system 304 can be an interface coupled to the browser 302. Before operation of the batch processing system 304, software can be downloaded from host server 206. When executed, the software could alter the browser 302 to include the batch processing system 304. In this embodiment, the system 304 uses a built in Internet Explorer (IE) control bar that interfaces with websites on a plurality of host servers 206 over network 210. The system 304 can enable users to retrieve information from a plurality of websites. Generally, it 304 strips the information required, formats it, then displays it on the monitor 146, which will be shown below.

The software may be written in C#, .Net 3.5 framework, or any other programming language that allows for similar robustness and workability. Such languages can include, but are not limited to, Java, C++, or C.

In other embodiments of this application, the batch processing system 304 is provided on a separate website generated by a host server 206. Through the website, the system 304 can be displayed therefore reducing the need to download software from a host server 206.

To generate revenue, typically the batch processing system 304 provides membership to those users 204 who pay a fee per day, month, year, or per use. The system 304 generally provides members with data and information only for personal, non-commercial use that is customarily and freely accessible to them via standard internet searches, or “surfing”, using standard browsers 302 and internet communication protocols from websites requiring no membership, no sign-in procedures, and requiring no click-wrap user agreements to access the site or respective content. Members can utilize the system 304 to render query results in a value-added manner designed to increase their usage of any searched site by providing greater efficiency, productivity, and customization to their internet search experience.

Batch processing system 304 is an internet solutions provider and normally generates revenue from the sale of memberships and is typically not a shopping, revenue sharing, or advertising dependent service. Members can benefit by significantly decreasing the time, effort, and costs needed to research and consume available products and services offered by selected or predetermined internet websites. Listings, products, or code rendered via system 304 and subsequently viewed, clicked, accessed, purchased or consumed, and any advertising seen or accessed by the members, can be done so directly at the respective searched site via the standard web browser 302 and user agent technology to and for the exclusive benefit of the searched website.

In addition, batch processing system 304 can offer to members, session oriented, human user-controlled, on-screen, real-time, targeted internet surfing for personal, non-commercial use designed to render freely offered internet HTML code to the members in a manner designed to meet their needs. Generally, the system 304 does not enable members to deep-link, robot, spider, or use other automated algorithms, devices, programs, or other methodologies to harvest or monitor any website, nor does it enable members to obtain any data not purposely made freely available to any user of the internet 172. The system 304 also does not typically probe, scan, or test the vulnerability of sites or any network connection to respective websites, nor does it breach the security or authentication measures of any site or any network 210. The system 304 does not make demonstrations, publish using net forums, conferences, third-party websites, mailing lists, bulletin board stems or spread and distribute the content of searched websites in any way by providing individual members with an alternative to generic internet browsing technology. Derivations of the policies, procedures, technology, and process herein described, including but not limited to delivering data to members from websites requiring sign-in procedures, can occur generally with the signed written agreement and authorization of the respective website owners and/or their authorized agents and the system 304.

The batch processing system 304 can efficiently render only one webpage 300, resultant from the entry of one query, at one website, to one member at a time for their individual, non-commercial use. The system 304 can conform and abide to all applicable copyright law and does not distribute, copy, harvest, frame, create derivative works from, save, sell, resell, alter, or exploit the copyrighted content of any website on the internet 172. The system 304 generally does not offer or provide crawling, page scraping, harvesting, or other automated or programmatic data mining or harvesting services or products. Each member can manually enter queries, manually begin search sessions, manually clear and begin subsequent search sessions, manually scan or save selected results, and manually link directly to originating websites to view, interact with, or utilize webpage content or listings.

Continuing with FIG. 3, the batch processing system 304 can incorporate a search box 306. To begin batch processing, typically the user 204 types in a search string 318 into the search box 306. In the alternative, the user can cut and paste in a long list of keywords. The keywords can also be fed in automatically through a process known within the relevant art. The search box 306 can expand lengthwise or widthwise when enough keywords are received. Each search string 318 can contain a plurality of keywords. For example, search string 318 contains keyword “Harry” 308, keyword “Potter” 310, keyword “Books” 312, keyword “DVDs” 314, and keyword “Clothes” 316. Quotations can generally be used to group words together to form combinations of keywords.

Typically, each line of the list capable search box 306 can distinguish keywords to specify a new item to be searched for through the plurality of host servers 206. As a result, this would simplify the processing required by the system 304. The separate lines within the search box 306 can provide the user with a more intuitive approach when copying and pasting from a spreadsheet.

In some embodiments, system 304 would remove formatting markers from the copied and pasted keywords. Often, text or spreadsheet programs, such as Microsoft's Word and Excel, incorporate formatting markers into their programs to distinguish ordinary text from other text. Furthermore, the markers could indicate special functions related to certain text within the programs. Because of this, system 304 can include functionalities and elements that remove or at least interpret these markers so that the text can be interpreted.

In some embodiments, user 204 can specify the host server 206 that the user 204 intends to search. The system 304 can monetize utility through various means including negotiating with targeted sites from a position of strength as a major driver of traffic to the sites. In this embodiment, the user 204 can place keywords along with the name of a host server 206 into the search box 306. In turn, the system 304 would create search queries for the specified keywords with the named host server 206. Alternatively, the search box 306 can include a preference section allowing the user 204 to list the names of the host servers 206 to be used.

By using keywords, several processes can be generated into a batch process. Each process can correspond to one keyword within the set of keywords and a host server 206. By making combinations of keywords and host servers 206, many processes can be stored in the batch process. Using keywords “Harry Potter Books”, “Harry Potter DVDs”, and “Harry Potter Clothes” along with Google host server 206, Amazon host server 206, and EBay host server 206, exemplary processes can be generated as follows: {Harry Potter Books, Google host server 206}; {Harry Potter Books, Amazon host server 206}; {Harry Potter Books, EBay host server 206}; {Harry Potter DVDs, Google host server 206}; {Harry Potter DVDs, Amazon host server 206}; {Harry Potter DVDs, EBay host server 206}; {Harry Potter Clothes, Google host server 206}; {Harry Potter Clothes, Amazon host server 206}; and {Harry Potter Clothes, EBay host server 206}.

After generating the combinations, the processes are executed or entered into the websites indicated by their respective host servers 206. The processes within the batch process can be executed concurrently or simultaneously to multiple sites, which often have an associated single line search box. In other embodiments, the processes can be executed when enough processing power is available. The idea behind the batch processing is that search queries incorporating keywords can be made to several host servers 206. This can be done by launching several processes at a time and dividing the parts. Once each process receives the “start” command, system 304 works on retrieving query results from each website published by each host server 206. This information can be stored into memory or some temporary location.

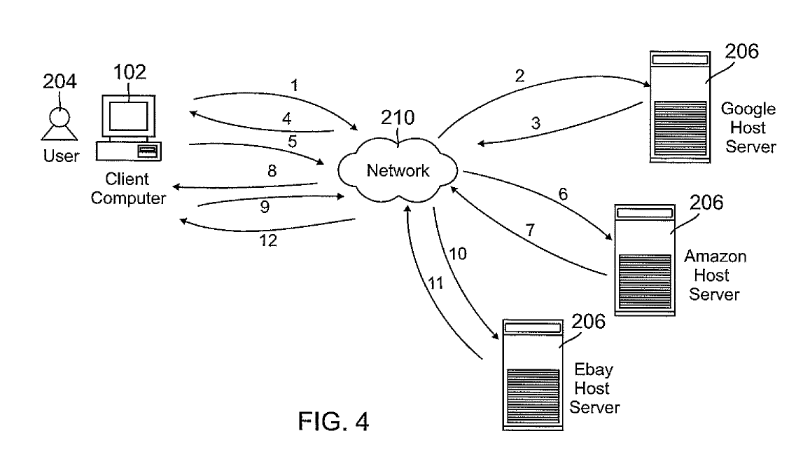

As shown in FIG. 4, illustrative routines for sending search queries to a number of host servers 206 is presented. Continuing with the Harry Potter illustration above, keywords “Harry Potter Books” are initially sent by client computer 102 through network 210 to Google host server 206. In turn, Google host server 206 returns with query results for “Harry Potter Books” to network 210, which then forwards the results to client computer 102.

Similarly, keywords “Harry Potter Books” are sent by client computer 102 through network 210 to Amazon host server 206. In turn, Amazon host server 206 returns with query results for “Harry Potter Books” to network 210, which then forwards the results to client computer 102.

Keywords “Harry Potter Books” are then sent by client computer 102 through network 210 to EBay host server 206. In turn, EBay host server 206 returns with query results for “Harry Potter Books” to network 210, which then forwards the results to client computer 102.

In addition, keywords “Harry Potter DVDs” and “Harry Potter Clothes” can be processed using the same or similar method described above. In the alternative, each keyword, “Harry Potter Books”, “Harry Potter DVDs”, and “Harry Potter Clothes” can be sent to one host server 206, then the next 206, and so on. While the query results were returned successively after a search query was made, client computer 102 can receive the query results in any mixed order from each of the host servers 206. Furthermore, client computer 102 can send keywords to the host server 206 simultaneously or through batches.

The query results from the search queries above are typically provided in the form of webpages. The webpages can include HTML code. The HTML code can include links pointing to listings associated with keyword matches. As will be shown below, the links can be used in a final grid presented to the user 204. Furthermore, the links can be placed within folders for easy gathering by the system 304.

When query results are returned from host server 206, a set of the results can be taken. For instance, Google host server 206 can provide thousands upon thousands of results. Batch processing system 304 would truncate the results to a set number, such as the first fifty (50) results, thereby eliminating the burden of storing and processing immaterial documents. The set of results can be stored into temporary files. Typically, the results are cached into memory or stored in a database (or hard drive) of client computer 102.

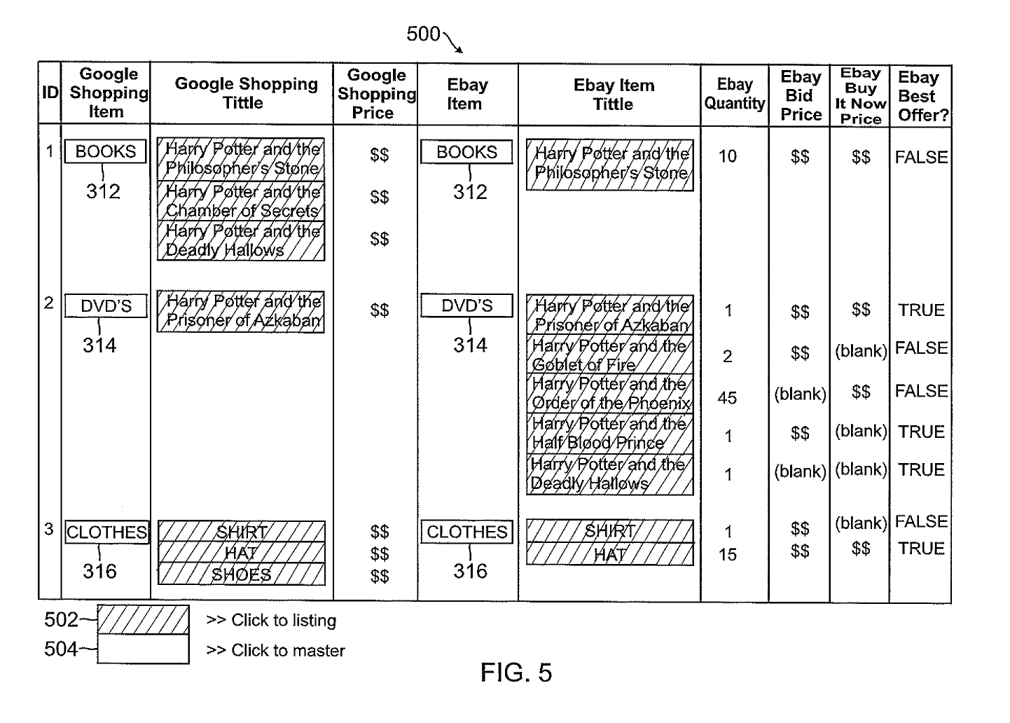

Often system 304 determines whether any processes are still working, Once processes have completed their work or timed out, batch processing system 304 retrieves the information from each process in the temporary files to create a grid 500 as depicted in FIG. 5. Once the information has been placed in the final grid 500, the grid 500 is uploaded on the screen where it is displayed. The grid 500 can be displayed in a spreadsheet application, separate browser 302, etc. Grid 500 is exemplary and should not be construed as limiting.

As shown, grid 500 can provide information for the user 204 to evaluate the query results pulled from the temporary files. Each column can represent fields for each host server 206 and relevant information that can be important to the user 204 when purchasing the product or service. “$$” represents an arbitrary value and is generally different each time displayed within grid 500. Displayed for each host server 206 is keyword “Books” 312, keyword “DVDs” 314, and keyword “Clothes” 316.

Items can be listed under keywords corresponding to the query results generated through the batch process. For example, under the Google host server 206 columns, items for keywords “Books” 312 include “Harry Potter and the Philosopher's Stone”, “Harry Potter and the Chamber of Secrets”, and “Harry Potter and the Deadly Hallows.” An item for keyword “DVDs” 314 includes “Harry Potter and the Prisoner of Azkaban”. Items for keyword “Clothes” 316 include “Shirt”, “Hat”, and “Shoes.” Each item can be associated with a price, which is listed to the right of the items on grid 500. Typically the items presented to the user 204 maintain the order in which the information was pulled from the website that was generated by the host server 206.

As further shown in FIG. 5, corresponding to those items displayed in the Google host server 206 columns, are the EBay host server 206 columns. Items are listed under the keywords corresponding to the query results generated through the batch process. For example, under the EBay host server 206 columns, an item for keyword “Books” 312 includes “Harry Potter and the Philosopher's Stone”. Noticeably, in the query search through EBay, only one match was made. Items for keyword “DVDs” 314 include “Harry Potter and the Prisoner of Azkaban”, “Harry Potter and the Goblet of Fire”, “Harry Potter and the Order of the Phoenix”, “Harry Potter and the Half Blood Prince”, and “Harry Potter and the Deadly Hallows.”

Because EBay provides different information in search queries, the columns associated with EBay host server 206 incorporate different topics that include “EBay Quantity”, “EBay Bid Price”, “EBay Buy it Now Price”, and “EBay Best Offer?”. When compared side-by-side, however, the items from Google host server 206 and EBay host server 206 can be easily compared making it easier for a user to make a determined choice.

Generally, batch processing system 304 does not provide the products or services themselves. Several links exist on the grid 500 so that the user can easily maneuver to the page. Grid 500 can provide a listing link 502 for each item found. In addition, grid 500 can provide a master link 504 that shows the results of the query using the specific keyword at the specific host server 206.

The rendering, as provided in grid 500, allows for vastly greater speed when uploading the data from the final grid 500 to the browser 302. In some embodiments, grid 500 does not contain bolds, colors, boxes, images, flash, etc. Furthermore, the data pulled into the grid 500 can be preprogrammed allowing only certain fields to be pulled from the host server's 206 query results. User's 204 can ask for items, titles, prices, rankings, model numbers, quantity, etc. Only a few strings per page could be pulled and therefore system 304 can query thousands of results in a relatively short time. For example, and as shown in FIG. 5, when query results are pulled from EBay, system 304 would pull information related to the EBay item, EBay Item Title, EBay Quantity, EBay Bid Price, EBay Buy it Now Price, and the EBay Best Offer information. All other information would be disregarded, thus allowing for system 304 to save processing time.

Furthermore, items can be listed by the order in which keywords were entered into the search boxes 306. For example, keyword “Books” 312 was listed first, keyword “DVDs” 314 was listed second, and keyword “Clothes” 316 was listed last. Grid 500 could then list “Books” as the first item, “DVDs” as the second item, and “Clothes” as the last item.

While the features of the previous embodiment are not entirely clear from grid 500, when a large amount of keywords are used and sent to the plurality of host servers 206, advantages can be immediately seen. For example, if a list of five hundred (500) keywords are sent to a plurality of host servers 206 and placed into the search box 306, the order in which the items are listed on the grid 500 correspond to the order in which the five hundred (500) keyword or queries were placed into the search box 306. So when user 204 requests for the results corresponding to the four hundred and thirty-fifth (435^{th}) keyword entered in, user 204 can scroll down quickly and easily to compare the results of the search on the grid 500 among the different host servers 206.

Another tool in an embodiment of system 304 is including blank spaces when one host server 206 generates more items than another host server 206. With reference to the previous Harry Potter illustration, the query results produced for keyword “Books” 312 by Google host server 206 lists three items: “Harry Potter and the Philosopher's Stone”, “Harry Potter and the Chamber of Secrets”, and “Harry Potter and the Deadly Hallows”. Items produced by the EBay host server 206 for keyword “Books” 312 include only “Harry Potter and the Philosopher's Stone”. Because only one item was generated by EBay host server 206, two blank rows have been added into grid 500 by system 304. Through the blanks, each item for each keyword can be placed in the same row for both host servers 206, consequently providing easy-to-use results to user 204.

The beneficial features provided by providing blank spaces will become apparent when additional queries are used. For example, when five hundred (500) queries are used and each query result produces fifty (50) items, potentially, twenty-five thousand (25,000) rows and fifty thousand (50,000) cells within grid 500 can exist. Through the blanks, the user 204 can easily determine side-by-side the results of each query. In one embodiment, the total rows are not numbered, only the rows containing the queries are.

In alternative embodiments, grid 500 can also be amended in queries generated after the initial query search has been made. For example, user 204 may generate additional keywords for the Harry Potter illustration. Instead of completely beginning the search from anew, the query results generated by additional keywords can be appended to the bottom of the grid 500.

In another embodiment, the query results can be displayed in Adobe Flash or similar program thereof. Adobe flash is a multimedia platform that is commonly used to create animation, advertisements, and various web page Flash components, to integrate video into web pages, and develop rich internet 172 applications.

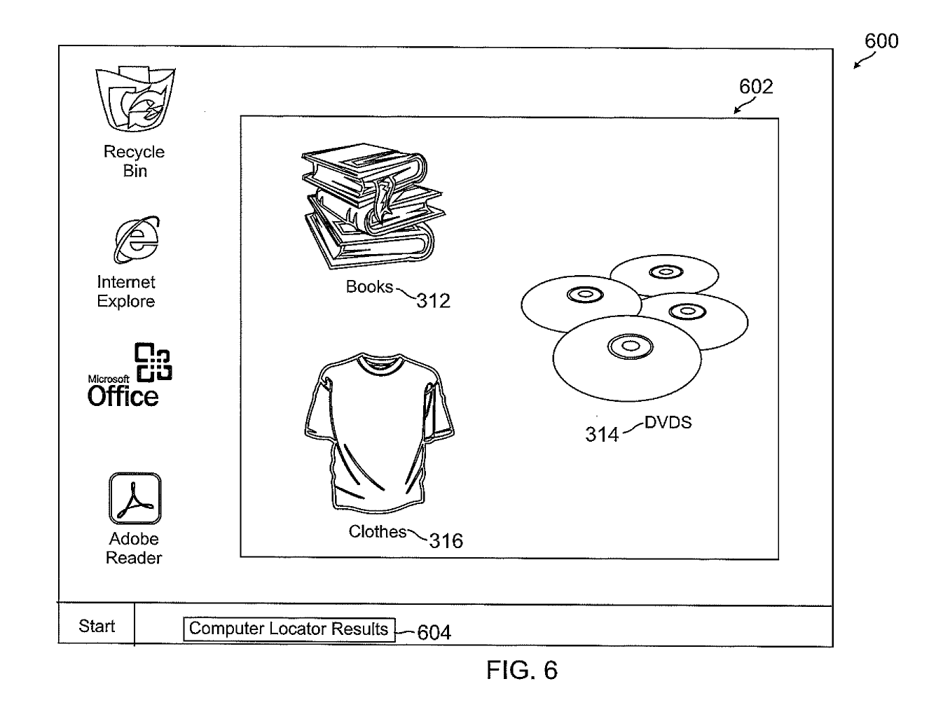

One skilled in the relevant art will appreciate that there are many ways to provide or display results to the user in accordance with the present application. As depicted in FIG. 6, illustrative query results can be provided within a folder 602 of an operating system 600. After the query results are generated, as described above, the results can be, in addition to or separately therefrom, be placed within a folder 600. In one embodiment, the folder 600 can include pictorial representations for the keywords entered in. For example, the results for the keyword Books 312, keyword DVDs 314, and keyword Clothes 316 can be placed within folder 602. Associated with folder 602, in some embodiments, is a folder icon 604 on a toolbar of operating system 600.

To retrieve query results, user 204 can simply “click” on the pictorial representation within folder 602. In one embodiment, separate folders can be provided for each host server 206 queried. In alternative embodiments, a grid can pop up showing only those items fitting under the keyword for each host server 206. Numerous implementations can be provided by the system 304 and those recited above should not be construed as limiting to the present application.

Briefly described above, system 304 can include an upload feature allowing a user 204 to provide keywords through an alternative method. In this embodiment, the system 304 could allow a user to upload an Excel spreadsheet or similar program thereof. Typically, the spreadsheet could remove formatting markers. One skilled in the relevant art will appreciate that the there are a number of ways to enter in keywords into system 304.

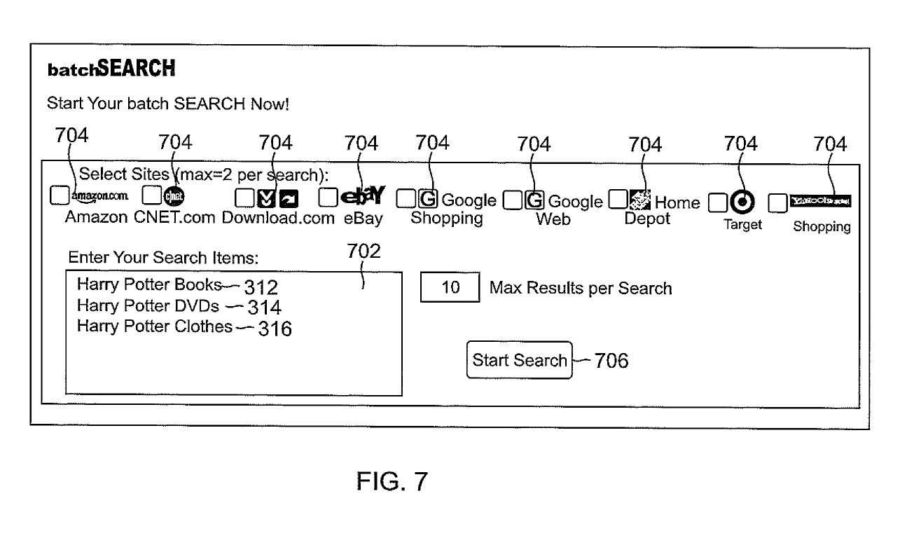

In accordance with yet another embodiment, and shown by FIG. 7, an interface titled “batchSEARCH” that provides system 304 is presented. For purposes of illustration, batchSEARCH can allow the user to choose from a variety of host servers 206 including, but not limited to, Amazon 704, CNET.com 704, Download.com 704, EBay 704, Google Shopping 704, Google Web 704, Home Depot 704, Target 704, and Yahoo! Shopping 704. In one embodiment, the user can choose and maintain the set of host servers 206 as they desire. In the alternative, the system 304 can manage and maintain the listed host servers 206. Generally, batchSEARCH can have a relationship with the search engines to draw in more traffic. By simply clicking on one of the sites 704, the user is directing the system 304 to search the selected host server 206.

batchSEARCH, in one embodiment, provides a list capable search box 702. Similar to the other embodiments described above, the list capable search box 702 can receive a long list of keywords, either cut and pasted in, typed in, fed in through an automated process, or some other method. As shown, the same keywords of “Harry Potter Books” 312, “Harry Potter DVDs” 314, and “Harry Potter Blothes” 316 have been provided to the search box 702.

After receiving the keywords, system 304 can batch search them into the selected sites 704. Typically, each site 704 has a single line search box common among search engines. Using button 706, the user can batch search the list of keywords into any typical website's search bar with one click. Another option provided within batchSEARCH is that the user can specify the number of results that they intend to display. batchSEARCH often does not go into any results that are not displayed on the first page of results. For example, Google can provide countless pages of results. batchSEARCH would thereafter retrieve those results displayed on the first page. As provided above, the one or more sites 704 can be searched simultaneously or in batches.

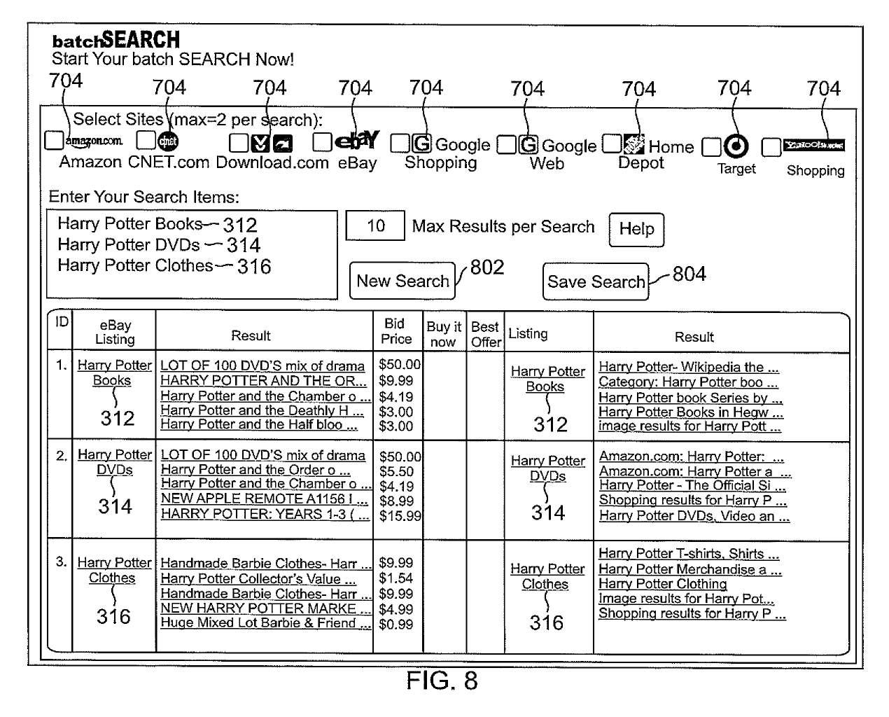

FIG. 8 shows exemplary results provided by batchSEARCH in accordance with one aspect of the present application. As shown, the EBay site 704 and Google site 704 were selected from the sites 704. Using those sites 704, keywords “Harry Potter Books” 312, “Harry Potter DVDs” 314, and “Harry Potter Clothes” 316 were entered into the single line search box of those sites 704. The results of those searches, as shown, are then displayed in a grid allowing true side by side comparison and scanning of the sites' 704 content.

The results for keyword “Harry Potter Books” 312 is followed by the results for keyword “Harry Potter DVDs” 314 followed by the results for keyword “Harry Potter Clothes” 316. While more details were provided above, each of the keywords 312, 314, and 316 are underlined indicating a direct link to the results of the search. Within the columns are the different selected sites 704. After the user evaluates the results from batchSEARCH, the user can start a new search by simply clicking on button 802. The user can also save the search results by clicking on button 804.

As provided for in the examples above, the user can create combinations for a broad range of internet and computer users such as price comparison shoppers, purchasing managers, SEO professionals, SEM professionals, EBay users, financial professionals, journalists, bloggers, taggers, social media experts, music and video collectors, attorneys, medical records professionals, educators, law enforcement personnel, researchers, and many more.

### Cookies

A cookie is typically a small piece of text stored on a client computer 102 by a web browser 300. Generally, cookies consist of one or more name-value pairs containing bits of information such as user preferences, shopping cart contents, the identifier for a server-based session, or other data used by websites.

Cookies can be sent to a client computer 102 through an HTTP header to a browser 300 and then sent back unchanged by the browser 300 each time it accesses the host server 206. Cookies can be used for authenticating a user 204, session tracking, and remembering specific information about the user 204 such as preferences. Alternatives to cookies can exists which are known to those skilled in the relevant art, such as objects.

In typical embodiments, when performing a batch process, system 304 can further include cookies stored from search websites. These cookies can be used for determining behavioral patterns of the user 204. Furthermore, cookies can allow a user 204 to access their own account or membership with a specific host server 206. For example, the cookie can include information related to an EBay account of the user 204.

In other embodiments, cookies can be used to specify which set of host servers 206 can be used. In one embodiment, cookies can allow the system 304 to distinguish which host servers 206 to use for what type of search. For example, if the user 204 is looking to find products and services, then the user 204 could use the Google host server 206, Craigslist host server 206, and Amazon host server 206 as described above. Alternatively, when the user 204 is searching for gossip articles, the system 304, through the cookies, could search Google host server 206, New York Times host server 206, or a Yahoo! host server 206.

### Methods of Operation

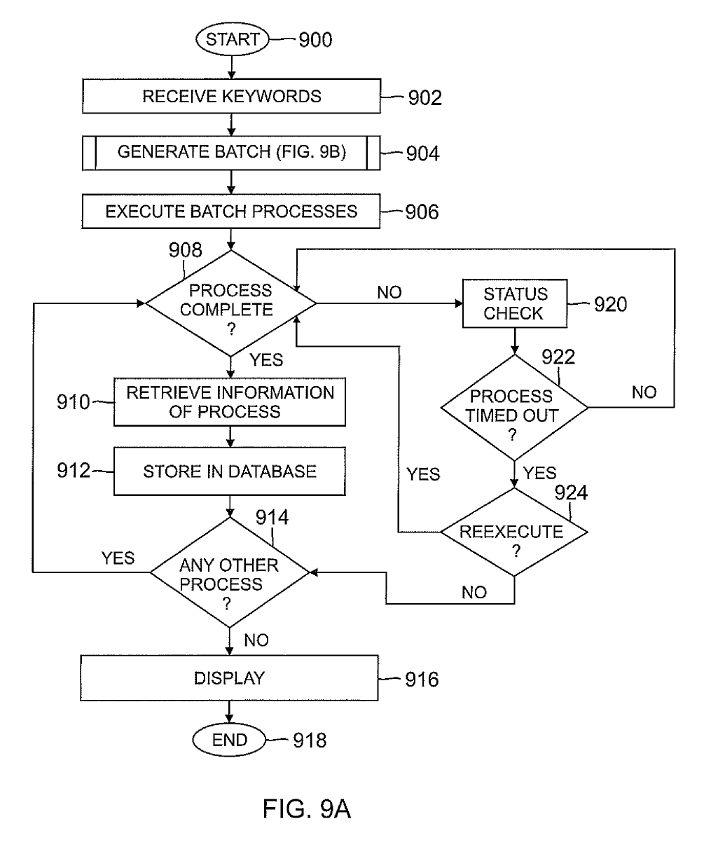

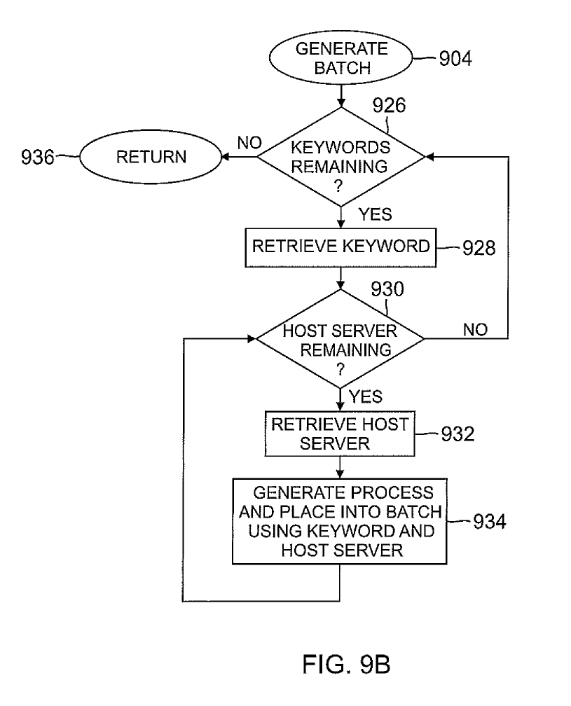

FIG. 9A is an exemplary flow chart showing illustrative routines used by system 304 to generate batch processes and then place the results into a grid 500 in accordance with one aspect of the present application. The system begins at block 900. The system 304 may begin by asking the user 204 to verify themselves, through a log-in procedure or other method. Otherwise, the system 304 can begin when keywords are received from the search box at block 902. Typically, the search box can be a list capable search box.

In turn, subroutine GENERATE BATCH at block 904 is executed. FIG. 9B is an exemplary flow chart showing illustrative processes for subroutine GENERATE BATCH in accordance with one aspect of the present application. The main purpose of the GENERATE BATCH subroutine is to generate a plurality of processes using a combination of keywords and host servers 206. At decision block 926, system 304 can determine whether there are any keywords remaining. When keywords remain, a keyword is retrieved at block 928.

At decision block 930, system 304 can determine whether any host server 206 remains. If so, at block 932, a host server 206 can be retrieved. A process can be generated and placed into the batch using the keyword and the host server 206 at block 934. Batch processing system 304 can then return to decision block 930.

When no host server remains, batch processing system 304 returns to decision block 926. If no keywords remain, subroutine 904 ends at block 936.

Returning to FIG. 9A, each process within the batch generated by the GENERATE BATCH subroutine can be executed at block 906. The processes may concurrently be executed or wait until memory is freed for another process to be executed.

At decision block 908, system 304 determines whether any process within the batch has been completed. When a process has been completed, information in the form of query results can be retrieved at block 910. In one embodiment, a subset of the query results is taken. For example, a query result can produce five hundred (500) listings. A subset of the listings would include fifty (50) listings or the first page produced from the query. Alternatively, user 204 can pick from one (1) to fifty (50) listings produced by the query results generated by host server 206. Through this, user 204 can control the primary aim of system 304. That is, user 204 can program system 304 to (a) quickly tell if the query results produced by host server 206 has the items at all or (b) take a few extra seconds or minutes but generate all the results of the first page for all queries. The information is therein stored in a temporary file or cached at block 912.

At decision block 914, system 304 determines whether any other processes are executing. When there are other executing processes, control is returned back to decision block 908. If not, all processes have completed their work. Information can be collected from the temporary files and used to generate and display the results to a user 204 at block 916. In some embodiments, client computer 102 receives the query results in the order that the host server 206 could have generated the results. No artificial intelligence to filter or manipulate the query results produced by the host server 306 can be used. The process ends at block 918.

Returning to decision block 908, a status check at block 920 is made when no process has been completed. Because a process may be errant, it is generally important to check all the processes that have not finished regularly. Batch processing system 304 can check with the processors to make sure that they are working and to stay informed of which process completed its work.

At decision block 922, system 304 determines whether any of the processes have timed out. A time out can occur when there is a network 210 error. On other occasions, a time out can occur when a host server 206 is not available. If no time out has occurred, control is returned to decision block 908.

If a time out has occurred, system 304 can determine whether the process should be re-executed. Typically, when the process has already been re-executed, system 304 does not try to again re-execute the process. When the process is re-executed, control is returned to decision block 908. Otherwise, control is returned to decision block 914.

Optionally, the query results can be updated using batch processing system 304. Because some host servers 206 provide limited quantities of items, such as EBay, the system 304 can automatically check if the item has been auctioned or sold off.

### Software Embodiments

The embodiments of the batch processing system 304 are preferably computer programs run on a computer system. One skilled in the relevant art will appreciate that the computer system can include code that is run on a hard drive of a computer system. Alternatively, the system 304 can be saved on a suitable storage medium such as a diskette, a CD, or like devices.

The system 304 can take the form of an entirely hardware embodiment, an entirely software embodiment or an embodiment containing both hardware and software elements. In one embodiment, the system is implemented in software, which includes but is not limited to firmware, resident software, microcode, etc.

Furthermore, the system 304 can take the form of a computer program product accessible from a computer-usable or computer-readable medium providing program code for use by or in connection with a computer or any instruction execution system. For the purpose of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium comprise a semiconductor or solid-state memory, magnetic tape, a removable computer diskette, a random access memory (RAM), a red-only memory (ROM), a rigid magnetic disk and an optical disk. Current examples of optical disks comprise compact disk-read only memory (CD-ROM), compact disk-read/write (CD-R/W) and DVD.

A data processing system suitable for storing and/or executing program code comprises at least one processor coupled directly or indirectly to memory elements through a system bus. The memory elements can include local memory employed during actual execution of the program code, bulk storage, and cache memories that provide temporary storage of at least some program code in order to reduce the number of times code is retrieved from bulk storage during execution.

Input/output or I/O devices (including but not limited to keyboards, displays, pointing devices, etc.) can be coupled to the system either directly or through intervening I/O controllers.

Network adapters may also be coupled to the system 304 to enable the data processing system to become coupled to other data processing systems or remote printers or storage devices through intervening private or public networks. Modems, cable modem and Ethernet cards are just a few of the currently available types of network adapters.

Described above, aspects of the present application are embodied in a World Wide Web (“WWW”) or (“Web”) site accessible via the internet 172. As is well known to those skilled in the art, the term “Internet” refers to the collection of networks and routers that use the Transmission Control Protocol/Internet Protocol (“TCP/IP”) to communicate with one another. The internet 172 can include a plurality of local area networks (“LANs”) and a wide area network (“WAN”) that are interconnected by routers. The routers are special purpose computers used to interface one LAN or WAN to another. Communication links within the LANs may be wireless, twisted wire pair, coaxial cable, or optical fiber, while communication links between networks may utilize 56 Kbps analog telephone lines, 1 Mbps digital T-1 lines, 45 Mbps T-3 lines or other communication links known to those skilled in the art.

Furthermore, computers and other related electronic devices can be remotely connected to either the LANs or the WAN via a digital communication device, modem and temporary telephone, or a wireless link. It will be appreciated that the internet 172 comprises a vast number of such interconnected networks, computers, and routers.

The internet 172 has recently seen explosive growth by virtue of its ability to link computers located through the world. As the internet 172 has grown, so has the WWW. As is appreciated by those skilled in the art, the WWW is a vast collection of interconnected or “hypertext” documents written in HyperText Markup Language (“HTML”) or other markup languages that are electronically stored at or dynamically generated by “WWW sites” or “Web sites” throughout the internet 172. Additionally, a client-side software program that communicates over the Web using the TCP/IP protocol can be part of the WWW, such as JAVA® applets, instant messaging, e-mail, browser plug-ins, Macromedia Flash, chat and others. Other interactive hypertext environments may include proprietary environments such as those provided in America Online or other online service providers, as well as the “wireless Web” provided by various wireless networking providers, especially those in the cellular phone industry. It will be appreciated that the present application could apply in any such interactive communication environments; however, for purposes of discussion, the Web is used as an exemplary interactive hypertext environment with regard to the present application.

A Web site is a server/computer connected to the internet 172 that has massive storage capabilities for storing hypertext documents and that runs administrative software for handling requests for those stored hypertext documents as well as dynamically generating hypertext documents. Embedded within a hypertext document are a number of hyperlinks i.e., highlighted portions of text which link the document to another hypertext document possibly stored at a Web site elsewhere on the internet 172. Each hyperlink is assigned a Uniform Resource Locator (“URL”) that provides the name of the linked document on a server connected to the internet 172. Thus, whenever a hypertext document is retrieved from any web server, the document is considered retrieved from the World Wide Web. Known to those skilled in the art, a web server may also include facilities for storing and transmitting application programs, such as application programs written in the JAVA® programming language from Sun Microsystems, for execution on a remote computer. Likewise, a web server may also include facilities for executing scripts and other application programs on the web server itself.

A remote access user may retrieve hypertext documents from the World Wide Web via a web browser program. A web browser, such as Netscape's NAVIGATOR® or Microsoft's Internet Explorer, is a software application program for providing a user interface to the WWW. Upon request from the remote access user via the web browser, the web browser requests the desired hypertext documents from the appropriate web server using the URL for the document and the HyperText Transport Protocol (“HTTP”). HTTP is a higher-level protocol than TCP/IP and is designed specifically for the requirements of the WWW. HTTP runs on top of TCP/IP to transfer hypertext documents and user-supplied form data between server and client computers. The WWW browser may also retrieve programs from the web server, such as JAVA applets, for execution on the client computer. Finally, the WWW browser may include optional software components, called plug-ins, that run specialized functionality within the browser.

### Systems, Methods, and Operations

In accordance with one aspect of the present application, a user computer system having a display screen, a graphical user interface (GUI) provided for on the display screen, and a search box displayed on the GUI for batch processing queries over a network is presented. The system includes a database for storing webpages and at least one processor. In addition, the system includes a memory operatively coupled to the processor, the memory storing program instructions that when executed by the processor, causes the processor to perform processes. The processes can include receiving at least one keyword from the user within the search box displayed on the GUI and generating a plurality of processes, each process corresponding to the at least one keyword and at least one predetermined website. In addition, the processes include executing search queries in batches for the plurality of processes over the network. The processes also include receiving a set of query results from the executed search queries for the plurality of processes from the network in the form of webpages that include hypertext markup language (HTML) code, the HTML code including links pointing to listings associated with keyword matches. The processes include storing the webpages that include the HTML code along with the links pointing to listings associated with the keyword matches into the database, wherein a subset of the HTML code and the links pointing to listings associated with keyword matches is stored when the amount of the HTML code and the links is greater than a predetermined size. Furthermore, the processes include displaying results on the GUI provided on the display screen using the webpages that include the HTML code along with the links pointing to listings associated with keyword matches from the database, wherein displaying the results using the HTML code and listings occurs after all processes within the plurality of processes have been completed and query results have been obtained or timed out, the results incorporating a link to the webpages from the search queries and the links within the HTML code that points to listings associated with the keyword matches, the links allowing the user to connected to the listings provided for in the query results from the executed search queries so that the user can view, interact with, or utilize the webpage's content.

In accordance with another aspect of the present application, a system is presented. The system includes at least one processor and a memory operatively coupled to the processor, the memory storing program instructions that when executed by the processor, causes the processor to perform processes. The processes include receiving at least one keyword and generating a plurality of processes, each process associated with the at least one keyword entered into at least one search engine. In addition, the processes include executing search queries for the plurality of processes and receiving a set of query results from the executed search queries for the plurality of processes, the query results from the at least one search engine. The processes also include displaying the query results.

In one embodiment, the query results are provided in HTML and further include hyperlinks that link to another document, the document associated within the at least one keyword entered into the at least one search engine. In another embodiment, the at least one search engine is predetermined. In another embodiment, generating a plurality of processes includes, for each keyword and for each search engine, creating a process for the keyword entered into the search engine and placing the process into a batch. In another embodiment, executing search queries for the plurality of processes includes taking each process from the batch and executing the process when computer resources are available. In another embodiment, generating a plurality of processes includes, for each search engine, creating a process for combinations of keywords entered into the search engine and placing the process into a batch. In another embodiment, displaying the query results includes creating a final grid when the plurality of processes have obtained query results or timed out. In another embodiment, displaying the query results includes creating a folder when the plurality of processes have obtained query results or timed out.

In accordance with yet another aspect of the present application, a computer-readable medium storing instructions for causing at least one processor to perform a method for processing queries is presented. The method includes receiving a plurality of keywords and generating search queries to a set of search engines using each keyword in the plurality of keywords, each search query producing query results. In addition, the method includes displaying the query results.

In one embodiment, the query results are displayed in a spreadsheet. In another embodiment, the spreadsheet shows the query results in an order the plurality of keywords were received. In another embodiment, the spreadsheet includes several links so the user can connect to a page reference by the link, the page associated with keyword matches. In another embodiment, a few strings of text are pulled from each query result. In another embodiment, the query results for each query are limited to a predetermined number of results. In another embodiment, the predetermined number of results is fifty. In another embodiment, receiving a plurality of keywords are entered through a search box displayed on a GUI. In another embodiment, receiving a plurality of keywords are retrieved through an upload feature. In another embodiment, the method further includes generating a new set of search queries using new keywords, each new search query producing new query results and attaching the new query results to the query results.

In accordance with still yet another aspect of the present application, a computer-implemented method for batch processing search queries to selected websites is presented. The method includes receiving a plurality of keywords and sending search queries using the plurality of keywords to selected websites, each search query producing query results in the form of HTML code. In addition, the method includes displaying the query results in the form of HTML code from the search queries.

In one embodiment, the plurality of websites include a single line search box. In another embodiment, the plurality of keywords are received through a list capable search box. In another embodiment, sending search queries using the plurality of keywords to selected websites includes combining a set of processes into multiple groups, each process associated with at least one keyword in the plurality of keywords and a selected websites and executing the processes within a group within the multiple groups when resources are available until each group within the multiple groups has been executed. In another embodiment, each process is associated with a combination of keywords. In another embodiment, the search query is re-sent after a period of time elapses. In another embodiment, the search query is abandoned after the search query has been re-sent a predetermined number of times. In another embodiment, the predetermined number of times is three. In another embodiment, the selected website is an online auction and shopping website. In another embodiment, the selected website is a search engine. In another embodiment, the selected website is an advertising website. In another embodiment, the query results in the form of HTML code are based on keyword matches using the plurality of keywords to the selected websites. In another embodiment, displayed query results include images copied from the query results. In another embodiment, the selected websites are determined by a user.

In accordance with another aspect of the present application, a system is presented. The system includes a database for storing query results and at least one processor. In addition, the system includes a memory operatively coupled to the processor, the memory storing program instructions that when executed by the processor, causes the processor to perform processes. The processes include receiving at least one keyword describing a desired product from a user agent and generating a plurality of processes, each process corresponding to the at least one keyword describing the product entered into a set of predetermined websites. In addition, the processes include executing search queries for the plurality of processes and receiving a set of query results from the executed search queries for the plurality of processes in the form of webpages having HTML code and links associated with products described by the at least one keyword. The processes include storing the query results into the database and creating a final grid using the query results from the database including the links associated with the products described by the at least one keyword from the webpages having HTML code. In addition, the processes include transmit the final grid to the user agent.

In one embodiment, a website within the set of predetermined websites has a limited quantity of products.

The foregoing description is provided to enable any person skilled in the relevant art to practice the various embodiments described herein. Various modifications to these embodiments will be readily apparent to those skilled in the relevant art, and generic principles defined herein may be applied to other embodiments. Thus, the claims are not intended to be limited to the embodiments shown and described herein, but are to be accorded the full scope consistent with the language of the claims, wherein reference to an element in the singular is not intended to mean “one and only one” unless specifically stated, but rather “one or more.” All structural and functional equivalents to the elements of the various embodiments described throughout this disclosure that are known or later come to be known to those of ordinary skill in the relevant art are expressly incorporated herein by reference and intended to be encompassed by the claims. Moreover, nothing disclosed herein is intended to be dedicated to the public regardless of whether such disclosure is explicitly recited in the claims.

What is claimed is:

1. A user computer system having a display screen, a graphical user interface (GUI) provided for on the display screen, and a search box displayed on the GUI for batch processing queries over a network, the system comprising:
a database for storing webpages;
at least one processor; and
a memory operatively coupled to the processor, the memory storing program instructions that when executed by the processor, causes the processor to:
receive at least one keyword from the user within the search box displayed on the GUI;
generate a plurality of processes, each process corresponding to the at least one keyword and at least one predetermined website;
execute search queries in batches for the plurality of processes over the network;
receive a set of query results from the executed search queries for the plurality of processes from the network in the form of webpages that include hypertext markup language (HTML) code, the HTML code including links pointing to listings associated with keyword matches;
store the webpages that include the HTML code along with the links pointing to listings associated with the keyword matches into the database, wherein a subset of the HTML code and the links pointing to listings associated with keyword matches is stored when the amount of the HTML code and the links is greater than a predetermined size;
display results on the GUI provided on the display screen using the webpages that include the HTML code along with the links pointing to listings associated with keyword matches from the database, wherein displaying the results using the HTML code and listings occurs after all processes within the plurality of processes have been completed and query results have been obtained or timed out, the results incorporating a link to the webpages from the search queries and the links within the HTML code that points to listings associated with the keyword matches, the links allowing the user to connected to the listings provided for in the query results from the executed search queries so that the user can view, interact with, or utilize the webpage's content.

2. A system comprising:
at least one processor; and
a memory operatively coupled to the processor, the memory storing program instructions that when executed by the processor, causes the processor to:
receive at least one keyword;
generate a plurality of processes, each process associated with the at least one keyword entered into at least one search engine;
execute search queries for the plurality of processes;
receive a set of query results from the executed search queries for the plurality of processes, the query results from the at least one search engine; and
display the query results.

3. The system of claim 2, wherein the query results are provided in HTML and further comprise hyperlinks that link to another document, the document associated within the at least one keyword entered into the at least one search engine.

4. The system of claim 2, wherein the at least one search engine is predetermined.

5. The system of claim 2, wherein generating a plurality of processes comprises, for each keyword and for each search engine, creating a process for the keyword entered into the search engine and placing the process into a batch.

6. The system of claim 5, wherein executing search queries for the plurality of processes comprises taking each process from the batch and executing the process when computer resources are available.

7. The system of claim 2, wherein generating a plurality of processes comprises, for each search engine, creating a process for combinations of keywords entered into the search engine and placing the process into a batch.

8. The system of claim 2, wherein displaying the query results comprises creating a final grid when the plurality of processes have obtained query results or timed out.

9. The system of claim 2, wherein displaying the query results comprises creating a folder when the plurality of processes have obtained query results or timed out.

10. A computer-readable medium storing instructions for causing at least one processor to perforin a method for processing queries, the method comprising:
receiving a plurality of keywords;
generating search queries to a set of search engines using each keyword in the plurality of keywords, each search query producing query results; and
displaying the query results.

11. The computer-readable medium of claim 10, wherein query results are displayed in a spreadsheet.

12. The computer-readable medium of claim 11, wherein the spreadsheet shows the query results in an order the plurality of keywords were received.

13. The computer-readable medium of claim 11, wherein the spreadsheet includes several links so the user can connect to a page reference by the link, the page associated with keyword matches.

14. The computer-readable medium of claim 10, wherein a few strings of text are pulled from each query result.

15. The computer-readable medium of claim 10, wherein the query results for each query are limited to a predetermined number of results.

16. The computer-readable medium of claim 15, wherein the predetermined number of results is fifty.

17. The computer-readable medium of claim 10, wherein receiving a plurality of keywords are entered through a list capable search box displayed on a GUI.

18. The computer-readable medium of claim 10, wherein receiving a plurality of keywords are retrieved through an upload feature.

19. The computer-readable medium of claim 10, wherein the method further comprises:
generating a new set of search queries using new keywords, each new search query producing new query results; and
attaching the new query results to the query results.

20. A computer-implemented method for batch processing search queries to selected websites, the method comprising:
receiving a plurality of keywords;
sending search queries using the plurality of keywords to selected websites, each search query producing query results in the form of HTML code; and
displaying the query results in the form of HTML code from the search queries.

21. The computer-implemented method of claim 20, wherein the plurality of websites include a single line search box.

22. The computer-implemented method of claim 20, wherein the plurality of keywords are received through a list capable search box.

23. The computer-implemented method of claim 20, wherein sending search queries using the plurality of keywords to selected websites comprises:
combining a set of processes into multiple groups, each process associated with at least one keyword in the plurality of keywords and a selected websites; and
executing the processes within a group within the multiple groups when resources are available until each group within the multiple groups has been executed.

24. The computer-implemented method of claim 23, wherein each process is associated with a combination of keywords.

25. The computer-implemented method of claim 23, wherein the search query is re-sent after a period of time elapses.

26. The computer-implemented method of claim 25, wherein the search query is abandoned after the search query has been re-sent a predetermined number of times.

27. The computer-implemented method of claim 26, wherein the predetermined number of times is three.

28. The computer-implemented method of claim 20, wherein the selected website is an online auction and shopping website.

29. The computer-implemented method of claim 20, wherein the selected website is a search engine.

30. The computer-implemented method of claim 20, wherein the selected website is an advertising website.

31. The computer-implemented method of claim 20, wherein the query results in the form of HTML code are based on keyword matches using the plurality of keywords to the selected websites.

32. The computer-implemented method of claim 20, wherein displayed query results comprise images copied from the query results.

33. The computer-implemented method of claim 20, wherein the selected websites are determined by a user.

34. A system comprising:
a database for storing query results;
at least one processor; and
a memory operatively coupled to the processor, the memory storing program instructions that when executed by the processor, causes the processor to:
receive at least one keyword describing a desired product from a user agent;
generate a plurality of processes, each process corresponding to the at least one keyword describing the product entered into a set of predetermined websites;
execute search queries for the plurality of processes;
receive a set of query results from the executed search queries for the plurality of processes in the form of webpages having HTML code and links associated with products described by the at least one keyword;
store the query results into the database;
create a final grid using the query results from the database including the links associated with the products described by the at least one keyword from the webpages having HTML code; and
transmit the final grid to the user agent.

35. The system of claim 34, wherein a website within the set of predetermined websites has a limited quantities of products.
